(19) United States
(12) Patent Application Publication
(10) Pub. No.: US 2025/0196552 A1
(43) Pub. Date: Jun. 19, 2025

(54) SIGNAL-ENHANCING CIRCUITS FOR A VEHICLE TRAIN AND METHODS THEREFOR

(71) Applicant: Bendix Commercial Vehicle Systems LLC, Avon, OH (US)

(72) Inventors: Owen M. Porpora, Wadsworth, OH (US); Michael D. Cremona, Lakewood, OH (US); Timothy J. Frashure, Columbia Station, OH (US); Dale B. Garrett, Avon, OH (US); Kritika Singhvi, Avon, OH (US); William R. Plow, Avon, OH (US)

(21) Appl. No.: 18/541,127

(22) Filed: Dec. 15, 2023

(51) Int. Cl. B60D 1/26

(52) U.S. Cl. CPC B60D 1/26

(57) ABSTRACT

A signal-enhancing apparatus is provided for a vehicle train having a tractor and first and second towed vehicles coupled to the tractor. The signal-enhancing apparatus comprises a first signal-enhancing circuit associated with the first towed vehicle and for enhancing a transmitted signal from the first towed vehicle. The signal-enhancing apparatus also comprises a second signal-enhancing circuit associated with the second towed vehicle and for enhancing a transmitted signal from the second towed vehicle. Each of the first and second signal-enhancing circuits is arranged to enhance its respective transmitted signal based upon the transmitted signal of the other towed vehicle.

### BACKGROUND

The present application relates to vehicle trains, and is particularly directed to signal-enhancing circuits for a vehicle train and methods therefor, such as for a vehicle train having a tractor and a plurality of towed vehicles coupled to the tractor.

In a typical vehicle train having a tractor and a plurality of towed vehicles coupled to the tractor, each of the plurality of towed vehicles has an associated controller that communicates with a controller of the tractor. Each towed vehicle controller provides towed vehicle information related to its respective towed vehicle. The tractor controller processes the towed vehicle information from the towed vehicles, and provides vehicle control functions based upon the processed information.

Despite advances already made, those skilled in the art continue with research and development efforts in the field of communications between members of a vehicle train, such as a vehicle train having a tractor and a plurality of towed vehicles coupled to the tractor.

### SUMMARY

In accordance with one embodiment, a signal-enhancing apparatus is provided for a vehicle train having a tractor and first and second towed vehicles coupled to the tractor. The signal-enhancing apparatus comprises a first signal-enhancing circuit associated with the first towed vehicle and for enhancing a transmitted signal from the first towed vehicle. The signal-enhancing apparatus also comprises a second signal-enhancing circuit associated with the second towed vehicle and for enhancing a transmitted signal from the second towed vehicle. Each of the first and second signal-enhancing circuits is arranged to enhance its respective transmitted signal based upon the transmitted signal of the other towed vehicle.

In accordance with another embodiment, an apparatus is provided for a vehicle train having a tractor and a plurality of towed vehicles coupled to the tractor. The apparatus comprises a power line, and means for enabling each of the plurality of towed vehicles to (i) detect voltage of the power line in vicinity of its respective towed vehicle, (ii) transmit the respective detected voltage to other towed vehicles of the plurality of towed vehicles, and (iii) adjust the respective transmitted voltage based upon at least one signal characteristic associated with the respective transmitted voltage relative to transmitted voltages of the other towed vehicles of the plurality of towed vehicles.

In accordance with yet another embodiment, a method is provided of operating each towed vehicle of a plurality of towed vehicles coupled to a tractor. The method comprises enhancing at the towed vehicle a characteristic of a transmitted signal from the towed vehicle based upon a relationship between the tractor and the plurality of towed vehicles.

### BRIEF DESCRIPTION OF THE DRAWINGS

FIG. 1 is a pictorial diagram of a vehicle train embodying an example control apparatus including a number of signal-enhancing circuits constructed in accordance with the present disclosure.

FIG. 1A is a schematic block diagram of the control apparatus shown in FIG. 1.

FIG. 2 is a schematic block diagram of an example tractor controller used in the control apparatus of FIG. 1A.

FIG. 3 is a schematic block diagram of an example towed vehicle controller used in the control apparatus of FIG. 1A.

FIG. 4 is a flow diagram depicting a method of operating the towed vehicle controller of FIG. 3 in accordance with an embodiment.

FIG. 5 is a flow diagram depicting a method of operating the tractor controller of FIG. 2 in accordance with an embodiment.

FIG. 6 is a flow diagram depicting a method of operating the towed vehicle controller of FIG. 3 in accordance with another embodiment.

FIG. 7 is a flow diagram depicting a method of operating the towed vehicle controller of FIG. 3 in accordance with yet another embodiment.

### DETAILED DESCRIPTION

The present application is directed to signal-enhancing circuits for a vehicle train and methods therefor, such as for a vehicle train having a tractor and a plurality of towed vehicles coupled to the tractor. The specific construction of the signal-enhancing circuits may vary. It is to be understood that the disclosure below provides a number of embodiments or examples for implementing different features of various embodiments. Specific examples of components and arrangements are described to simplify the present disclosure. These are merely examples and are not intended to be limiting.

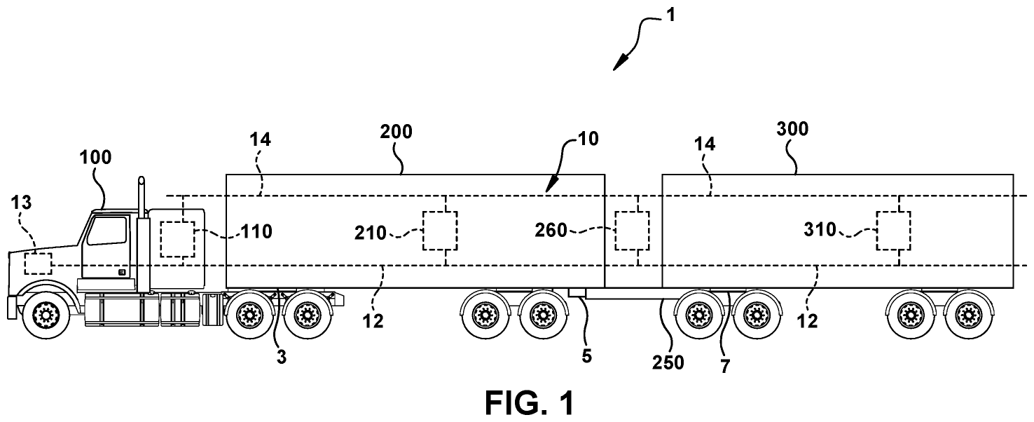

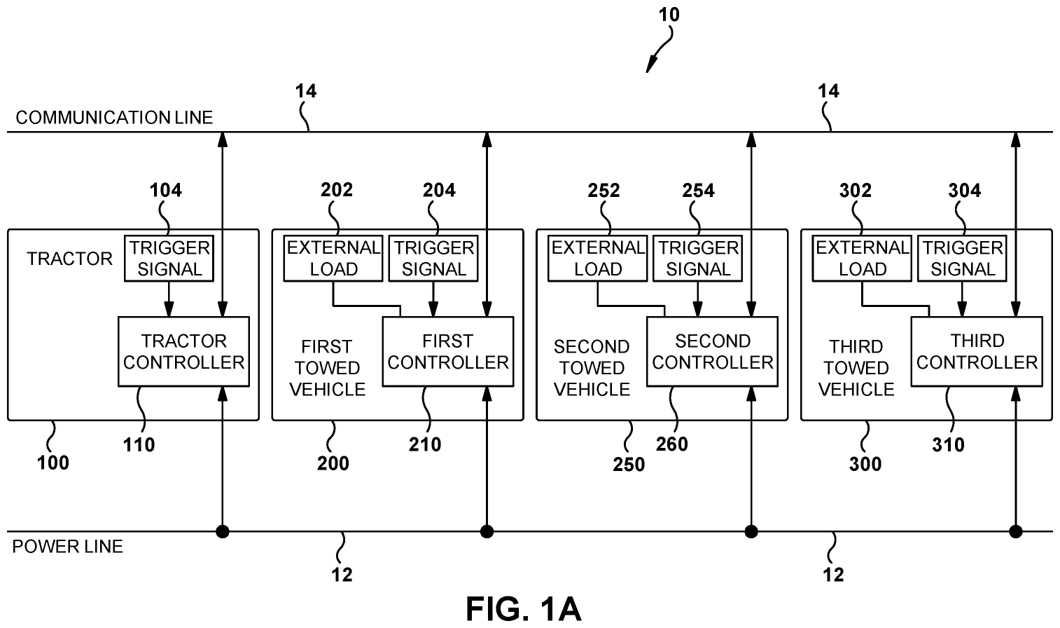

Referring to FIG. 1, a pictorial diagram is illustrated of a vehicle train 1 embodying an example control apparatus 10 constructed in accordance with the present disclosure. The control apparatus 10 comprises a number of signal-enhancing circuits (not shown in FIG. 1) that will be described later.

The vehicle train 1 has a tractor 100 and a plurality of towed vehicles including first trailer 200, dolly 250, and second trailer 300 coupled to the tractor 100. A mechanical coupling 3 mechanically interconnects the tractor 100 and the first trailer 200 in known and conventional manner. The dolly 250 includes a hook portion 5 that connects to rear end of the first trailer 200, and a plate portion 7 that connects to front end of the second trailer 300. The dolly 250 mechanically interconnects the first trailer 200 and the second trailer 300 in known and conventional manner.

Although the above description describes three towed vehicles (i.e., the first trailer 200, the dolly 250, and the second trailer 300) coupled to the tractor 100, it is conceivable that any number of towed vehicles can be coupled to the tractor 100. As an example, five towed vehicles (i.e., three trailers and two dollies) may be coupled to the tractor 100.

The control apparatus 10 includes an electronic controller unit (ECU) 110 of the tractor 100, an ECU 210 of the first trailer 200, an ECU 260 of the dolly 250, and an ECU 310 of the second trailer 300. The ECU 110 is referred to herein as “the tractor controller 110”, the ECU 210 is referred to herein as “the first controller 210” or “the first towed controller 210”, the ECU 260 is referred to herein as “the second controller 260” or “the second towed controller 260”, and the ECU 310 is referred to herein as “the third controller 310” or “the third towed controller 310”. Each of the controllers 110, 210, 260, 310 is connected to a power line 12, and is connected to a communication line 14. The power line 12 may be connected to vehicle battery 13.

The communication line 14 may comprise a controller area network (CAN) bus to which a number of vehicle devices are connected to communicate with each other. The CAN bus may be in a standardized serial communication format, such as SAE J1939, or in a proprietary format. The communication line 14 creates a communication path through tractor and trailers that may or may not be shown or described herein via wired (e.g., controller area network (CAN), ethernet, automotive ethernet, etc.) or wireless (e.g., WiFi, Bluetooth, cellular, etc.) connections. In the example in FIG. 1, the components are directly or indirectly connected via the communication line 14, which can take the form of a controller area network (e.g., J1939, ISO 11992, or proprietary format). Other types of network communication are possible. It is also conceivable that the power line 12 may comprise the communication line 14. This is known as power line communication in which the power line 12 carries data in addition to delivering electric power to electronic components and devices.

Referring to FIG. 1A, a schematic block diagram of the control apparatus 10 shown in FIG. 1 is illustrated. The tractor controller 110 is responsive to a trigger signal 104 that may be provided from a driver-operable switch (not shown) located in the driver compartment of the tractor 100. The vehicle driver operates the switch to provide the trigger signal 104 to obtain a ranking of the order of the plurality of towed vehicles including the first trailer 200, the dolly 250, and the second trailer 300 in tow by the tractor 100, as will be described later.

The first controller 210 is connectable to an external load 202 to which voltage from the power line 12 in vicinity of the first controller 210 can be applied. The external load 202 may comprise an energizable solenoid, for example, in which the solenoid is energized to provide a temporary load. Other types of loads are possible. The first controller 210 is responsive to a trigger signal 204 that may comprise the trigger signal 104 from the tractor 100, or alternatively, from a processor within the first controller 210 as will be described later.

The second controller 260 is connectable to an external load 252 to which voltage from the power line 12 in vicinity of the second controller 260 can be applied. The external load 252 may comprise a solenoid-type of load, for example. Other types of loads are possible. The second controller 260 is responsive to a trigger signal 254 that may comprise the trigger signal 104 from the tractor 100, or alternatively, from a processor within the second controller 260 as will be described later. Similarly, the third controller 310 is connectable to an external load 302 to which voltage from the power line 12 in vicinity of the third controller 310 can be applied. The external load 302 may comprise a solenoid-type of load, for example. Other types of loads are possible. The third controller 310 is responsive to a trigger signal 304 that may comprise the trigger signal 104 from the tractor 100, or alternatively, from a processor within the third controller 310 as will be described later.

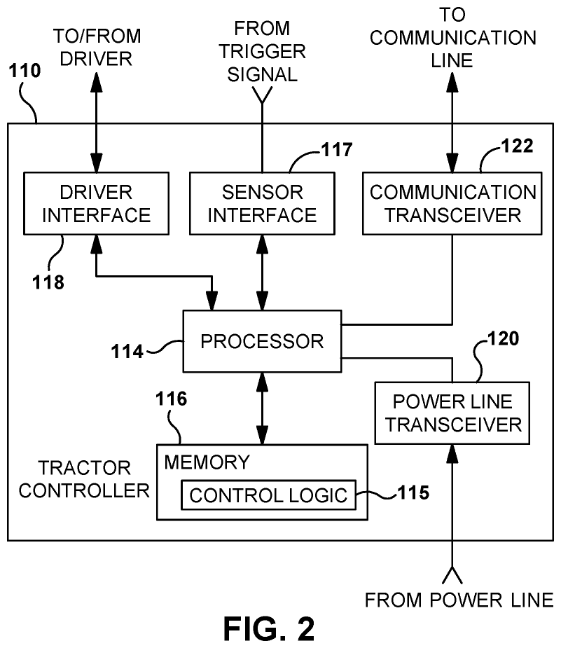

Referring to FIG. 2, a schematic block diagram of the tractor controller 110 is illustrated. The tractor controller 110 includes a processor 114 that executes instructions of control logic 115 stored in an internal memory 116, external memory (not shown), or a combination thereof. The processor 114 may comprise any type of technology. For example, the processor 114 may comprise a general-purpose electronic processor. Other types of processors and technologies are possible. The internal memory 116 may comprise any type of technology. For example, the internal memory 116 may comprise random access memory (RAM), read only memory (ROM), solid state memory, or any combination thereof. Other types of memories and data storage technologies are possible.

The tractor controller 110 also includes a vehicle sensor interface 117 that may comprise any type of technology. The sensor interface 117 enables communication between the processor 114 and vehicle sensors such as wheel speed sensors, pressure sensors, acceleration sensors (i.e., accelerometers), and steering angle sensors, for example. Other types of vehicle sensors and technologies are possible.

The tractor controller 110 further includes a vehicle driver interface 118 that may comprise any type of technology. For example, the driver interface 118 may comprise any combination of visual, audible, and haptic devices. Other types of driver devices and technologies are possible. Information can be received by or sent to the driver via the driver interface 118.

A power line transceiver 120 enables the processor 114 to send/receive signals to/from the power line 12. Similarly, a communication line transceiver 122 enables the tractor controller 110 to send/receive signals to/from the communication line 14. Structure and operation of transceiver circuits are known and, therefore, will not be described. The transceiver circuits may send/receive signals based upon any type of network communication of the communication line 14.

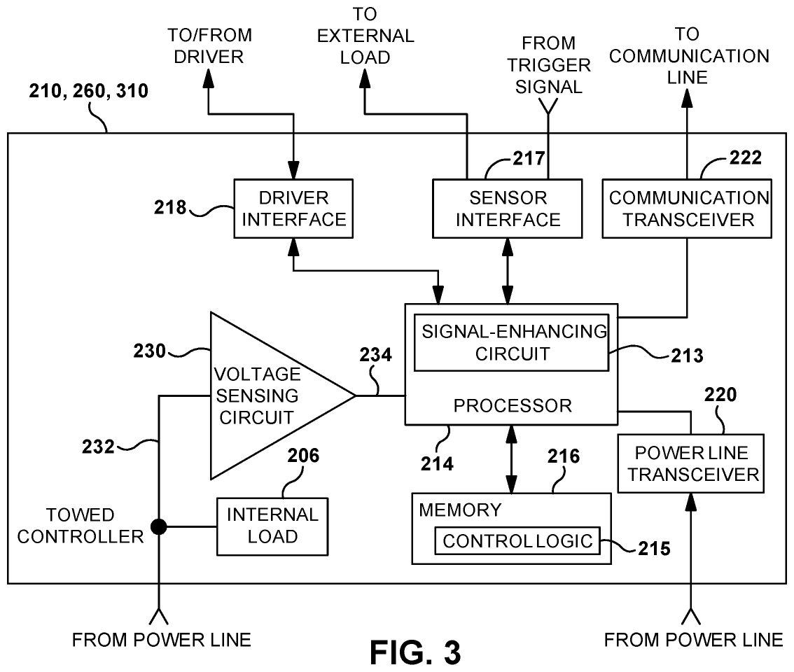

Referring to FIG. 3, a schematic block diagram of each of the first, second, and third towed controllers 210, 260, 310 is illustrated. Each of the first, second, and third towed controllers 210, 260, 310 may comprise components similar to components of the tractor controller 110 described hereinabove. Each of the first, second, and third towed controllers 210, 260, 310 is constructed and operates in similar manner. For simplicity and purpose of explanation, components and operation of only the first towed controller 210 are described with reference to FIG. 3.

As shown in FIG. 3, the first controller 210 includes a processor 214 that executes instructions of control logic 215 stored in an internal memory 216, external memory (not shown), or a combination thereof. The processor 214 includes a signal-enhancing circuit 213, such as a circuit that improves strength of a signal or a circuit that improves a signal-to-noise ratio (power/gain) output of a signal, for example. Other types of signal-enhancing circuits are possible. The signal-enhancing circuit 213 is arranged to improve at least one signal characteristic of a transmitted power line voltage signal that has been detected in vicinity of the first controller 210, as will be described later.

Although the signal-enhancing circuit 213 in FIG. 3 as being located within the processor 214, it is conceivable that the signal-enhancing circuit 213 be located outside of the processor 214 and within the first controller 210. It is also conceivable that the signal-enhancing circuit 213 be located outside of the first controller 210. The signal-enhancing circuit 213 may comprise any combination of hardware components, software components, and firmware components.

The processor 214 may comprise any type of technology. For example, the processor 214 may comprise a general-purpose electronic processor. Other types of processors and technologies are possible. The internal memory 216 may comprise any type of technology. For example, the internal memory 216 may comprise random access memory (RAM), read only memory (ROM), solid state memory, or any combination thereof. Other types of memories and data storage technologies are possible.

The first controller 210 also includes a vehicle sensor interface 217 that may comprise any type of technology. The sensor interface 217 enables communication between the processor 214 and vehicle sensors such as wheel speed sensors, pressure sensors, acceleration sensors (i.e., accelerometers), and steering angle sensors, for example. Other types of vehicle sensors and technologies are possible.

The first controller 210 further includes a vehicle driver interface 218 that may comprise any type of technology. For example, the driver interface 218 may comprise any combination of visual, audible, and haptic devices. Other types of driver devices and technologies are possible.

A power line transceiver 220 enables the processor 214 to send/receive signals to/from the power line 12. Similarly, a communication line transceiver 222 enables the processor 214 to send/receive signals to/from the communication line 14. Structure and operation of transceiver circuits are known and, therefore, will not be described. The transceiver circuits may send/receive signals based upon any type of network communication of the communication line 14.

The first controller 210 also includes an internal load 206 to which voltage from the power line 12 in vicinity of the first controller 210 can be applied. The internal load 206 may comprise a solenoid-type of load, for example. Other types of loads are possible.

A voltage sensing circuit 230 senses on input line 232 the voltage across the internal load 206, and provides on output line 234 an output voltage signal to the processor 214 for further processing. The voltage sensing circuit 230 may comprise an analog-to-digital voltage converter with a sample-and-hold, for example. Structure and operation of voltage sensing circuits are known and conventional and, therefore, will not be described.

In an example implementation, the first controller 210 is arranged to measure voltage of the power line 12 in vicinity of the first controller 210, and then transmit the measured voltage along the communication line 14 to other controllers of the vehicle train 1 (shown in FIG. 1). The other controllers to which the measured voltage of the power line 12 in vicinity of the first controller 210 is transmitted include, but are not limited to, the tractor controller 110, the second controller 260, and the third controller 310 (all shown in FIG. 1A). Identification information such as an identification number associated with the first towed vehicle 200, and thus also associated with the first controller 210, is also transmitted to the other controllers.

The voltage of the power line 12 in vicinity of the first controller 210 is measured by applying a load that includes a combination of the internal load 206 (FIG. 3) and the external load 202 (FIG. 1A). The first controller 210 is triggered by the trigger signal 204 to measure voltage across the combination of the internal load 206 and the external load 202. The trigger signal 204 at the first controller 210 may originate from the control logic 115 (FIG. 2) of the tractor controller 110, and transmit via the communication line 14 to the first controller 210. A trigger signal originating from the tractor controller 110 (shown as trigger signal 104 in FIG. 1A) may be provided in response to a vehicle driver operating a manual switch or operating a brake-pedal switch, for example. Alternatively, the trigger signal 204 may originate from the control logic 215 (FIG. 3) of the first controller 210.

A trigger signal, whether originating from the control logic 115 of the tractor controller 110 or from the control logic 215 of the first controller 210, is an external means to start the voltage measuring process. When triggered, the combination of the internal load 206 and the external load 202 is connected as a momentary load to the power line 12 to induce a voltage drop from line losses at input of the first controller 210. The voltage drop is then measured by components of the first controller 210.

The second controller 260 is arranged to measure voltage of the power line 12 in vicinity of the second controller 260, and then transmit the measured voltage along the communication line 14 to other controllers of the vehicle train 1. The other controllers to which the measured voltage of the power line 12 in vicinity of the second controller 260 is transmitted include, but are not limited to, the tractor controller 110, the first controller 210, and the third controller 310. Identification information such as an identification number associated with the second towed vehicle 250, and thus also associated with the second controller 260, is also transmitted to the other controllers.

The voltage of the power line 12 in vicinity of the second controller 260 is measured by applying a load that includes a combination of an internal load (which is like the internal load 206 shown in FIG. 3) and the external load 252 (FIG. 1A). The second controller 260 is triggered by the trigger signal 254 to measure voltage across the combination of internal and external loads. The trigger signal 254 at the second controller 260 may originate from the control logic 115 of the tractor controller 110, and transmit via communication line 14 to the second controller 260 in the same manner as described hereinabove for the first controller 210.

Similarly, the third controller 310 is arranged to measure voltage of the power line 12 in vicinity of the third controller 310, and then transmit the measured voltage along the communication line 14 to other controllers of the vehicle train 1. The other controllers to which the measured voltage of the power line 12 in vicinity of the third controller 310 is transmitted include, but are not limited to, the tractor controller 110 and the first and second controllers 210, 260. Identification information such as an identification number associated with the second trailer 300, and thus also associated with the third controller 310, is also transmitted to the other controllers.

The voltage of the power line 12 in vicinity of the third controller 310 is measured by applying a load that includes a combination of an internal load (which is like the internal load 206 shown in FIG. 3) and the external load 302 (FIG. 1A). The third controller 310 is triggered by the trigger signal 304 to measure voltage across the combination of internal and external loads. The trigger signal 304 at the third controller 310 may originate from the control logic 115 of the tractor controller 110, and transmit via communication line 14 to the third controller 310 in the same manner as described hereinabove for the first controller 210.

It should be apparent that control logic 215 (FIG. 3) of the first controller 210 enables the first controller 210, when triggered, to not only transmit a measured voltage but also an identification number that identifies the first towed vehicle 200 from which the measured voltage is transmitted. Control logic (not shown) of the second controller 260 enables the second controller 260, when triggered, to not only transmit a measured voltage but also an identification number that identifies the second towed vehicle 260 from which the measured voltage is transmitted. Similarly, control logic (also not shown) of the third controller 310 enables the third controller 310, when triggered, to not only transmit a measured voltage but also an identification number that identifies the third towed vehicle 300 from which the measured voltage is transmitted.

The tractor controller 110 receives the transmitted voltages from the first, second, and third controllers 210, 260, 310, as well as transmitted voltages from other controllers of other towed vehicles that may be coupled to the tractor 100. The control logic 115 of the tractor controller 110 then determines order of all towed vehicles including the first, second, and third towed vehicles 200, 260, 300 relative to the tractor 100 based upon transmitted voltages received from all towed controllers. It is assumed that the lowest transmitted voltage corresponds to the towed vehicle farthest from the tractor 100, and the highest transmitted voltage corresponds to the towed vehicle closest to the tractor 100. The ranking of the order of the towed vehicles relative to the tractor 100 and, thus also relative to each other, allows the tractor controller 110 to provide various vehicle control functions that are based upon knowing the order of all of the towed vehicles including the first, second, and third towed vehicles 200, 260, 300 coupled to the tractor 100.

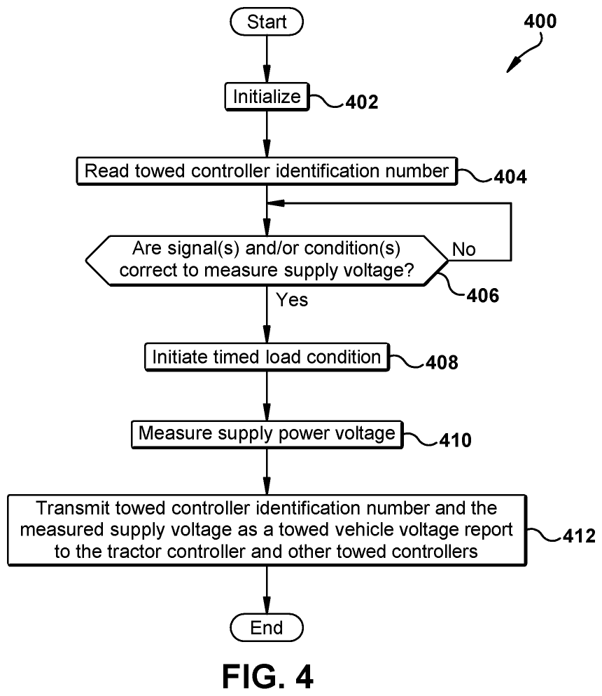

Referring to FIG. 4, a flow diagram 400 depicts an example method of operating the first controller 210 (and therefore also an example method of operating the second and third controllers 260, 310) of FIG. 3 in accordance with an embodiment. The flow diagram 400 is an embodiment of the control logic 215 shown in FIG. 3, and will be referred to herein as “control logic 215”.

The control logic 215 in block 402 begins with an initialization before proceeding to block 404 in which an identification number associated with the first controller 210 is read. The process then proceeds to block 406 in which a determination is made as to whether one or more signals and/or one or more conditions are correct to measure the supply voltage on power line 12 in vicinity of the first controller 210.

Examples of one or more signals and/or one or more conditions to be checked for correctness include the following list:
Is a wheel sensor zero or below a minimum measurable speed?
Is parking brake released or applied as set by configuration?
Is trailer controller running within time limit of power on reset?
Is a pneumatic braking signal within a predetermined pressure/force?
Is an electrical braking signal received from another controller?

Other one or more signals and/or one or more conditions to check for correctness are possible for block 406 in the flow diagram 400 of FIG. 4.

If the determination in block 406 is negative (i.e., the one or more signals and/or one or more conditions are not correct), the process returns back to block 406 to continue monitoring for correctness of the one or more signals and/or the one or more conditions. However, if the determination in block 406 is affirmative (i.e., the one or more signals and/or one or more conditions are correct), the process proceeds to block 408.

In block 408, supply voltage from power line 12 is applied to the combination of the internal load 206 and the external load 202 to initiate a timed load condition. The process proceeds to block 410 in which the supply voltage of the power line 12 in vicinity of the first controller 210, and therefore also in vicinity of the first towed vehicle 200, is measured. Then in block 412, the identification number obtained in block 404 and the measured voltage obtained in block 410 are transmitted together as a towed vehicle voltage report from the first controller 210 via the communication line 14 to the tractor controller 110 and other towed vehicle controllers including the second and third controllers 260, 310. The process of control logic 215 then ends.

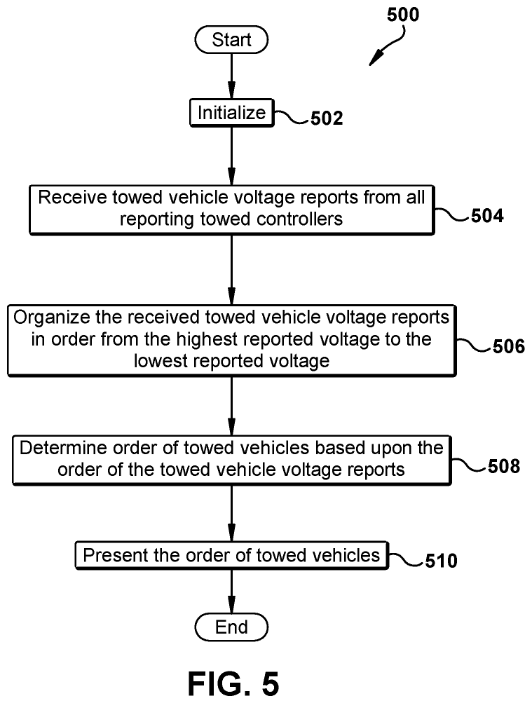

Referring to FIG. 5, a flow diagram 500 depicts an example method of operating the tractor controller 110 of FIG. 2 in accordance with an embodiment. The flow diagram 500 is an embodiment of the control logic 115 shown in FIG. 2, and will be referred to herein as “control logic 115”.

The control logic 115 in block 502 begins with an initialization before proceeding to block 504 in which towed vehicle voltage reports are received from all reporting towed controllers including the first, second, and third controllers 210, 260, 310. Then in block 506, the towed vehicle voltage reports are organized in order (i.e., ranked) from the highest reported voltage to the lowest reported voltage. The process then proceeds to block 508.

In block 508, an order of the towed vehicles is determined based upon the order of the towed vehicle voltage reports. The process proceeds to block 510 in which the order of the towed vehicles is presented. As an example, the order of the towed vehicles may be presented on a visual display located in the cab compartment of the tractor 100. The process of control logic 115 then ends.

It should be apparent that the control logic 215 enables the first controller 210 to determine power supply signal information (i.e., the drop in voltage of the power line 12 as measured in vicinity of the first controller 210), and then to transmit the power supply signal information to the tractor controller 110 and other trailer controllers including the second and third controllers 260, 310 of the second and third trailers 250, 300. Thus, not only does the controller of each trailer transmit a measured voltage associated with that particular controller, but the controller also receives measured voltages transmitted from controllers of all other towed vehicles that are coupled to the tractor 100.

It should also be apparent that the control logic 115 of the tractor controller 110, the control logic 215 of the first controller 210, and control logic from all other towed controllers including the second and third controllers 260, 310 are integrated into a practical application of providing a useful and reliable report of the order of all of the towed vehicles including the first, second, and third towed vehicles 200, 250, 300 that are coupled to the tractor 100.

A number of advantages result by providing a vehicle with the above-described control apparatus 10 of FIG. 1A to provide the capability for either the vehicle driver to trigger the voltage measurement process to determine towed vehicle order or the control logic of the controller of a particular towed vehicle (e.g., the control logic 215 of the first controller 210 of the first trailer 200) to trigger the voltage measurement process to self-determine its towed vehicle position in the order of towed vehicles. One advantage is that the tractor controller 110 can use the order of the towed vehicles to better perform other vehicle functions. Another advantage is ability is provided to send braking requests to any number of specific axles or axle groups on any number of specific towed vehicles.

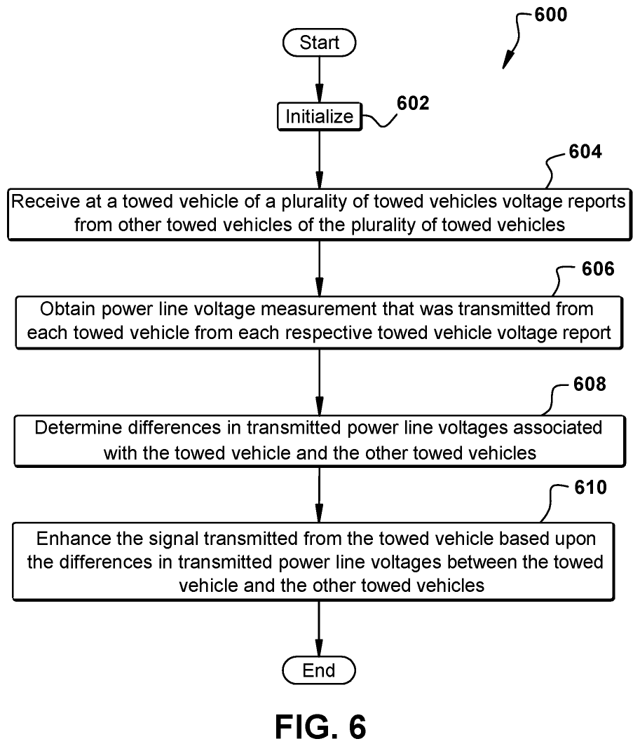

Referring to FIG. 6, a flow diagram 600 depicts an example method of operating the first controller 210 (and therefore also an example method of operating the second and third controllers 260, 310) of FIG. 3 in accordance with another embodiment. The flow diagram 600 is another embodiment of the control logic 215 shown in FIG. 3.

The control logic 215 in block 602 begins with an initialization before proceeding to block 604 in which towed vehicle voltage reports from other towed controllers (i.e., from the second controller 260 and the third controller 310 in the disclosed example shown in FIG. 1) are received. The process proceeds to block 606 in which the power line voltage measurement that was transmitted from each towed vehicle is obtained (i.e., read) from each respective towed vehicle voltage report received in block 604.

Then, in block 608, a determination or calculation is made of differences in transmitted power line voltages associated with the first controller 210 of the first towed vehicle 200 (FIG. 1) and the towed controllers of the other towed vehicles (i.e., the second towed vehicle 260 and the third towed vehicle 300). The process then proceeds to block 610 in which the signal transmitted from the first towed vehicle 200 is enhanced based upon the differences in transmitted power line voltages as determined or calculated in block 608. The signal transmitted from the first towed vehicle 200 may comprise a power line voltage value (i.e., a signal value) that is continuously changing in real-time. Accordingly, the signal value of the power line voltage in vicinity of the first towed vehicle 200 is being continuously enhanced in real-time by the signal-enhancing circuit 213 shown in FIG. 3. The process then ends.

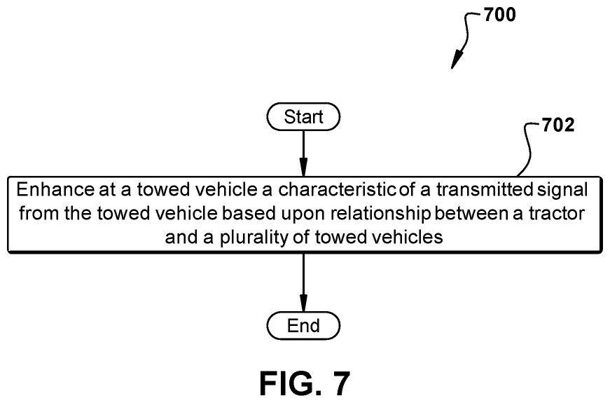

Referring to FIG. 7, a flow diagram 700 depicts an example method of operating the first controller 210 (and therefore also an example method of operating the second and third controllers 260, 310) of FIG. 3 in accordance with yet another embodiment. The flow diagram 700 is another embodiment of the control logic 215 shown in FIG. 3.

In block 702, a characteristic of a transmitted signal from a towed vehicle of a plurality of towed vehicles is enhanced based upon relationship between a tractor and the plurality of towed vehicles. The process then ends.

In some embodiments, a characteristic of a transmitted power line voltage in vicinity of the towed vehicle is enhanced based upon differences in transmitted power line voltages associated with the towed vehicle and other towed vehicles of the plurality of towed vehicle. In some embodiments, a signal strength characteristic of the transmitted power line voltage in vicinity of the towed vehicle is adjusted. In some embodiments, a signal-to-noise ratio output of the transmitted power line voltage in vicinity of the towed vehicle is adjusted.

In some embodiments, the method further comprises transmitting an identifier associated with the towed vehicle and the transmitted signal along a communication line to other towed vehicles of the plurality towed vehicles.

In some embodiments, a characteristic of a continuously changing transmitted signal from the towed vehicle is enhanced. In some embodiments, the characteristic of the continuously changing transmitted signal from the towed vehicle is enhanced in real-time such that all transmitted signals from all towed vehicles of the plurality of towed vehicles are successfully received at the tractor.

In some embodiments, the method is performed by a controller having a memory executing one or more programs of instructions which are tangibly embodied in a program storage medium readable by the controller.

It should be apparent that each transmitted power line voltage of its respective towed vehicle corresponds to a spatial relationship (e.g., order) between the respective towed vehicle and the tractor 100. The spatial relationship may comprise position of the respective towed vehicle relative to the tractor 100, such as described above. It is conceivable that other ways of determining position of the respective towed vehicle relative to the tractor 100 are possible. Alternatively, or in addition to, the spatial relationship may comprise distance of the respective towed vehicle relative to the tractor 100. In this case, distance can be determined or calculated based upon wire lengths between the towed vehicle and the tractor 100 or type of the towed vehicle, for example.

It should further be apparent that a signal-enhancing apparatus comprising a plurality of signal-enhancing circuits are provided in the above-described example implementation. The plurality of signal-enhancing circuits includes first, second, and third signal-enhancing circuits associated with the first, second, and third towed vehicles 200, 250, 300, respectively. Each signal-enhancing circuit is arranged to enhance its respective transmitted signal based upon the transmitted signals in vicinity of the other towed vehicles. Each transmitted signal corresponds to a spatial relationship, such as towed vehicle order, between the tractor 100 and the respective towed vehicle. The towed vehicle order may comprise position of the towed vehicle relative to the tractor 100 or distance of the towed vehicle relative to the tractor 100.

It should also be apparent that each respective transmitted power line voltage is adjusted based upon at least one signal characteristic associated with the respective transmitted power line voltage relative to transmitted power line voltages of the other towed vehicles of the plurality of towed vehicles. The at least one signal characteristic associated with the respective transmitted power line voltage may comprise signal strength of the respective transmitted voltage, or a signal-to-noise ratio output of the respective transmitted voltage. The signal strength of each transmitted voltage at its respective towed vehicle is increased in proportion to the voltage drops reported from all reporting towed controllers including the first, second, and third controllers 210, 260, 310.

A number of advantages result by providing a vehicle with the above-described signal-enhancing circuit 213 of FIG. 3 to enhance the transmitted power line voltage in vicinity of the first towed vehicle 200. One advantage is that the overall success rate of communications from the first towed vehicle 200 (and thus also from each of the second and third towed vehicles 250, 300) to the tractor 100 is improved. This ensures that the tractor 100 receives communication messages from all of the towed vehicles including the first, second, and third towed vehicles 200, 250, 300.

Another advantage is that the signal strength of each transmitted power line voltage at its respective towed vehicle is continuously enhanced in real-time and is autonomously set with no feedback required from other towed vehicles. This is advantageous because the tractor 100 is ensured to successfully receive all messages (i.e., all transmitted signals) from all towed vehicles regardless of message format. The tractor 100 establishes the order of all of the trailers based upon all of the real-time messages received. By knowing the order of the trailers, additional features can be enabled.

Program instructions for enabling each of the controllers 110, 210, 260, 310 (FIG. 1A) to perform operation steps in accordance with corresponding flow diagrams may be embedded in memory internal to each respective controller. Alternatively, or in addition to, program instructions may be stored in memory external to each respective controller. As an example, program instructions may be stored in memory internal to a different controller of the vehicle. Program instructions may be stored on any type of program storage media including, but not limited to, external hard drives, flash drives, and compact discs. Program instructions may be reprogrammed depending upon features of the particular controller.

Aspects of disclosed embodiments may be implemented in software, hardware, firmware, or a combination thereof. The various elements of the system, either individually or in combination, may be implemented as a computer program product tangibly embodied in a machine-readable storage device for execution by a processor. Various steps of embodiments may be performed by a computer processor executing a program tangibly embodied on a computer-readable medium to perform functions by operating on input and generating output. The computer-readable medium may be, for example, a memory, a transportable medium such as a compact disk or a flash drive, such that a computer program embodying aspects of the disclosed embodiments can be loaded onto a computer.

Although the above description describes use of only one controller in the tractor 100 and only one controller in each of the dolly 250 and the first and second trailers 200, 300, it is conceivable that any number of controllers may be used. Moreover, it is conceivable that any type of controller may be used. Suitable controllers for use in vehicles are known and, therefore, have not been described. Accordingly, the program instructions of the present disclosure can be stored on program storage media associated with one or more vehicle controllers.

While the present invention has been illustrated by the description of example processes and system components, and while the various processes and components have been described in detail, applicant does not intend to restrict or in any way limit the scope of the appended claims to such detail. Additional modifications will also readily appear to those skilled in the art. The invention in its broadest aspects is therefore not limited to the specific details, implementations, or illustrative examples shown and described. Accordingly, departures may be made from such details without departing from the spirit or scope of applicant's general inventive concept.

What is claimed is:

1. A signal-enhancing apparatus for a vehicle train having a tractor and first and second towed vehicles coupled to the tractor, the signal-enhancing apparatus comprising:
a first signal-enhancing circuit associated with the first towed vehicle and for enhancing a transmitted signal from the first towed vehicle; and
a second signal-enhancing circuit associated with the second towed vehicle and for enhancing a transmitted signal from the second towed vehicle;
wherein each of the first and second signal-enhancing circuits is arranged to enhance its respective transmitted signal based upon the transmitted signal of the other towed vehicle.

2. A signal-enhancing apparatus according to claim 1, wherein each of the transmitted signals comprises a power line voltage detected in vicinity of its respective towed vehicle.

3. A signal-enhancing apparatus according to claim 2, wherein each of the first and second signal-enhancing circuits is arranged to adjust signal strength of its respective detected power line voltage.

4. A signal-enhancing apparatus according to claim 2, wherein each of the first and second signal-enhancing circuits is arranged to adjust a signal-to-noise ratio output associated with its respective detected power line voltage.

5. A signal-enhancing apparatus according to claim 1, wherein each of the transmitted signals corresponds to a spatial relationship between the tractor and the first and second towed vehicles.

6. A signal-enhancing apparatus according to claim 5, wherein the spatial relationship between the tractor and the first and second towed vehicles comprises order of the first and second towed vehicles relative to the tractor.

7. A signal-enhancing apparatus according to claim 6, wherein the order between the tractor and the first and second towed vehicles comprises position of the first towed vehicle relative to the tractor and position of the second towed vehicle relative to the tractor.

8. A signal-enhancing apparatus according to claim 6, wherein the order between the tractor and the first and second towed vehicles comprises distance of the first towed vehicle relative to the tractor and distance of the second towed vehicle relative to the tractor.

9. A signal-enhancing apparatus according to claim 1, wherein the first towed vehicle comprises a first trailer, and the second towed vehicle comprises a dolly.

10. An apparatus for a vehicle train having a tractor and a plurality of towed vehicles coupled to the tractor, the apparatus comprising:
a power line; and
means for enabling each of the plurality of towed vehicles to (i) detect voltage of the power line in vicinity of its respective towed vehicle, (ii) transmit the respective detected voltage to other towed vehicles of the plurality of towed vehicles, and (iii) adjust the respective transmitted voltage based upon at least one signal characteristic associated with the respective transmitted voltage relative to transmitted voltages of the other towed vehicles of the plurality of towed vehicles.

11. An apparatus according to claim 10, wherein the at least one signal characteristic associated with the respective transmitted voltage comprises signal strength of the respective transmitted voltage.

12. An apparatus according to claim 10, wherein the at least one signal characteristic associated with the respective transmitted voltage comprises a signal-to-noise ratio output of the respective transmitted voltage.

13. An apparatus according to claim 10, wherein (i) a vehicle battery comprises the power line, and (ii) the plurality of towed vehicles comprises first and second trailers and a dolly interconnecting the first and second trailers.

14. An apparatus according to claim 10, wherein each transmitted voltage of the power line in vicinity of the respective towed vehicle corresponds to position of the respective towed vehicle relative to the tractor.

15. An apparatus according to claim 10, wherein each transmitted voltage of the power line in vicinity of the respective towed vehicle corresponds to distance of the respective towed vehicle relative to the tractor.

16. A method of operating each towed vehicle of a plurality of towed vehicles coupled to a tractor, the method comprising:
enhancing at the towed vehicle a characteristic of a transmitted signal from the towed vehicle based upon a relationship between the tractor and the plurality of towed vehicles.

17. A method according to claim 16, wherein enhancing at the towed vehicle a characteristic of a transmitted signal from the towed vehicle based upon a relationship between the tractor and the plurality of towed vehicles includes:
enhancing at the towed vehicle a characteristic of a transmitted power line voltage in vicinity of the towed vehicle based upon differences in transmitted power line voltages associated with the towed vehicle and other towed vehicles of the plurality of towed vehicles.

18. A method according to claim 17, wherein enhancing at the towed vehicle a characteristic of a transmitted power line voltage measurement in vicinity of the towed vehicle based upon differences in transmitted power line voltages associated with the towed vehicle and other towed vehicles of the plurality of towed vehicles includes:
adjusting at the towed vehicle a signal strength characteristic of the transmitted power line voltage in vicinity of the towed vehicle.

19. A method according to claim 17, wherein enhancing at the towed vehicle a characteristic of a transmitted power line voltage in vicinity of the towed vehicle based upon differences in transmitted power line voltages associated with the towed vehicle and other towed vehicles of the plurality of towed vehicles includes:
adjusting at the towed vehicle a signal-to-noise ratio output of the transmitted power line voltage in vicinity of the towed vehicle.

20. A method according to claim 16 further comprising:
transmitting an identifier associated with the towed vehicle and the transmitted signal along a communication line to other towed vehicles of the plurality towed vehicles.

21. A method according to claim 16, wherein enhancing at the towed vehicle a characteristic of a transmitted signal from the towed vehicle based upon a relationship between the tractor and the plurality of towed vehicles includes:
enhancing at the towed vehicle a characteristic of a continuously changing transmitted signal from the towed vehicle.

22. A method according to claim 21, wherein enhancing at the towed vehicle a characteristic of a continuously changing transmitted signal from the towed vehicle includes:
enhancing in real-time at the towed vehicle the characteristic of the continuously changing transmitted signal from the towed vehicle such that all transmitted signals from all towed vehicles of the plurality of towed vehicles are successfully received at the tractor.

23. A method according to claim 16, wherein the method is performed by a controller having a memory executing one or more programs of instructions which are tangibly embodied in a program storage medium readable by the controller.
